(19) United States
(12) Patent Application Publication
(10) Pub. No.: US 2019/0105763 A1
(43) Pub. Date: Apr. 11, 2019

(54) SCREW CLAMPING DEVICE

(71) Applicant: NATIONAL CHUNG SHAN INSTITUTE OF SCIENCE AND TECHNOLOGY, TAOYUAN CITY (TW)

(72) Inventors: Han-Hsiang Chang, Taoyuan CIity (TW); Kui-Chin Liu, Taoyuan City (TW); Yung-Lin Lin, Taoyuan City (TW)

(21) Appl. No.: 15/874,073

(22) Filed: Jan. 18, 2018

(30) Foreign Application Priority Data
Oct. 6, 2017 (TW) 106134568

(51) Int. Cl. B25B 23/10; B25B 15/02

(52) U.S. Cl. CPC B25B 23/101; B25B 15/02

(57) ABSTRACT

A screw clamping device includes a body, a pressing unit, a resilient unit, a clamping unit and a connecting unit. The body is a hollow-core cylinder, is subject to axial penetration of a screwdriver, and is movable axially in synchrony with rotation of the screwdriver. The pressing unit is disposed on the body and adapted to press against a surface of a working object. The resilient unit is disposed between the body and the pressing unit. The clamping unit is rotatably connected to the body. The connecting unit has one end connected to the pressing unit and the other end connected to the clamping unit. While the body is moving axially, the connecting unit drives the clamping unit to rotate and thereby clamp or loosen screws.

### CROSS-REFERENCE TO RELATED APPLICATION

This non-provisional application claims priority under 35 U.S.C. § 119(a) on Patent Application No(s). 106134568 filed in Taiwan, R.O.C. on Oct. 6, 2017, the entire contents of which are hereby incorporated by reference.

### FIELD OF THE INVENTION

The present invention relates to a clamping device and, more particularly, to a screw clamping device for clamping screws.

### BACKGROUND OF THE INVENTION

In general, machines, electronic apparatuses, and fittings are usually assembled and fixed in place by screws. However, screws being tightened or loosened with a screwdriver are likely to fall off the screwdriver for lack of physical connection between the screwdriver and each screw. Furthermore, it is difficult to tighten or loosen screws in limited operating space. Moreover, any screw detached and buried in a machine may damage the machine and thus cause enormous financial losses. Last but not least, physical connection between a screw and a magnetic screwdriver is improved, albeit insufficient, let alone unfit for use with screws made of non-magnetic materials, such as copper, aluminum and stainless steel. In attempt to improve the aforesaid prior art, screw clamping devices are developed to prevent screws from falling off while being tightened or loosened.

In attempt to prevent screws from falling off while being tightened or loosened, some conventional screw clamping devices feature a screwdriver with a tip made of a resilient material. The resilient screwdriver tip is of a special shape and is deformed as soon as the screwdriver is pressed downward under a force. The resilient screwdriver tip thus deformed clamps or releases a screw. However, the resilient screwdriver tip in operation is deformed too little to enable the screwdriver tip to come into contact with a screw. Furthermore, the deformed resilient screwdriver tip is of too low mechanical strength to clamp a screw tightly, thereby causing the screw to loosen. The other conventional screw clamping devices feature a movable mechanism for controlling a chuck to open and shut but have disadvantages as follows: inconvenient to use (because manual operation is required) and structurally complicated.

### SUMMARY OF THE INVENTION

In view of the aforesaid drawbacks of the prior art, it is an objective of the present invention to provide a screw clamping device whereby screws are clamped to prevent the screws from falling off or even getting missing while being loosened or tightened.

Another objective of the present invention is to provide a screw clamping device coupled to a screwdriver by modularization to further broaden the application of the screw clamping device.

In order to achieve the above and other objectives, the present invention provides a screw clamping device which comprises a body, a pressing unit, a resilient unit, a clamping unit and a connecting unit. The body is a hollow-core cylinder, is subject to axial penetration of a screwdriver, and is movable axially in synchrony with rotation of the screwdriver. The pressing unit is pressed against the body and adapted to press against a surface of a working object. The resilient unit is disposed between the body and the pressing unit. The clamping unit is rotatably connected to the body. The connecting unit has one end connected to the pressing unit and the other end connected to the clamping unit. The connecting unit drives the clamping unit to rotate while the body is moving axially.

While a user is operating the screwdriver, the body is driven to move, whereas the connecting unit drives the clamping unit to rotate and thereby clamp or loosen the screws.

In an embodiment, the clamping unit comprises at least a clamping arm with an end in the form of a C-shaped object.

In an embodiment, an end of the pressing unit comprises an L-shaped object.

In an embodiment, an end of the body has a plurality of dents for receiving the pressing unit and the clamping unit.

In an embodiment, the body has an inner wall, and the screwdriver is in tight contact with the inner wall for fixing the body.

In an embodiment, the clamping arms are in the number of two and symmetrically arranged on the clamping unit, with the two C-shaped objects formed at the two clamping arms, respectively, obliquely in opposite directions.

According to another objective of the present invention, the present invention provides a screw clamping device which comprises a body, a fixing unit, a pressing unit, a resilient unit, a clamping unit and a connecting unit. The body is a hollow-core cylinder which is subject to axial penetration of a screwdriver. The fixing unit is connected to the body axially and fixed with the screwdriver, and the fixing unit is driven to press against the body to move axially when the screwdriver is rotating. The pressing unit presses against the body and is adapted to press against a surface of a working object. The resilient unit is disposed between the body and the pressing unit. The clamping unit is rotatably connected to the body. The connecting unit has one end connected to the pressing unit and another one end connected to the clamping unit. The connecting unit drives the clamping unit to rotate while the body is moving axially.

Thus, the screw clamping device uses the fixing unit to push the body to move axially. When the screwdriver is rotating, the screwdriver only driving the fixing unit to rotate, and the body, the pressing unit, the clamping unit and the connecting unit only move up and down. Therefore, the screw clamping device is more stable in the operation.

In an embodiment, the clamping unit comprises at least a clamping arm with an end in the form of a C-shaped object.

In an embodiment, an end of the pressing unit is an L-shaped object.

In an embodiment, an end of the body has a plurality of dents for receiving the pressing unit and the clamping unit.

In an embodiment, the fixing unit comprises a plurality of screws penetratingly disposed at the fixing unit to press against the screwdriver.

In an embodiment, the clamping arms are in the number of two and symmetrically arranged on the clamping unit, with the two C-shaped objects formed at the two clamping arms, respectively, wherein the two C-shaped objects are oblique in opposite directions.

### BRIEF DESCRIPTION OF THE DRAWINGS

FIG. 1 is a schematic view of a screw clamping device according to an embodiment of the present invention;

FIG. 2 is an explode view of the screw clamping device of FIG. 1;

FIG. 3 is a schematic view in another perspective of the screw clamping device of FIG. 1;

FIG. 4 is a clamping schematic view of the screw clamping device of FIG. 1;

FIG. 5 is a schematic view of operation of the screw clamping device of FIG. 1;

FIG. 6 is a schematic view of operation of the screw clamping device of FIG. 1;

FIG. 7 is an unclamping schematic view of the screw clamping device of FIG. 1;

FIG. 8 is an expanded schematic view of a clamping unit of the screw clamping device of FIG. 1;

FIG. 9 is an expanded schematic view of the clamping unit of the screw clamping device of FIG. 1;

FIG. 10 is a restored schematic view of the screw clamping device of FIG. 1; and

FIG. 11 is a schematic view of the screw clamping device according to another embodiment of the present invention.

### DETAILED DESCRIPTION OF THE PREFERRED EMBODIMENTS

Implementation of the present invention is hereunder illustrated by specific embodiments. Persons skilled in the art can easily understand other advantages and effects of the present invention by referring to the disclosure contained in the specification.

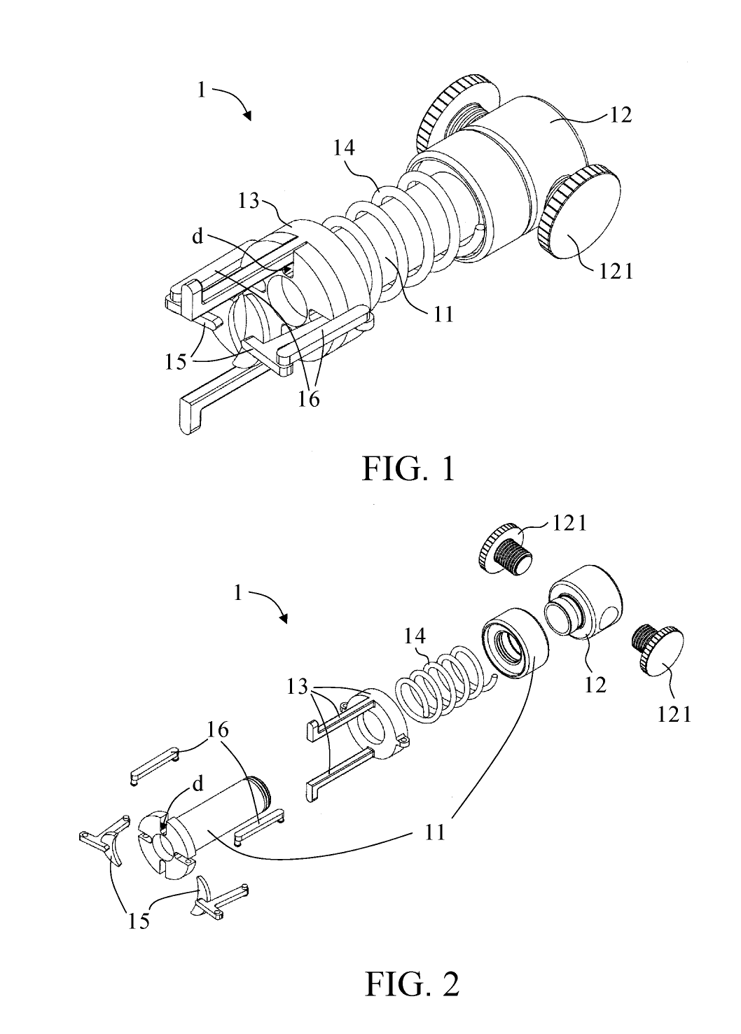

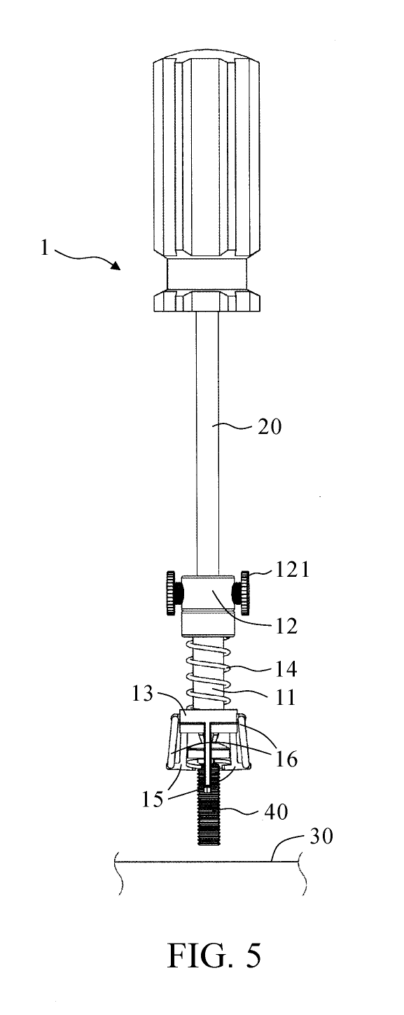

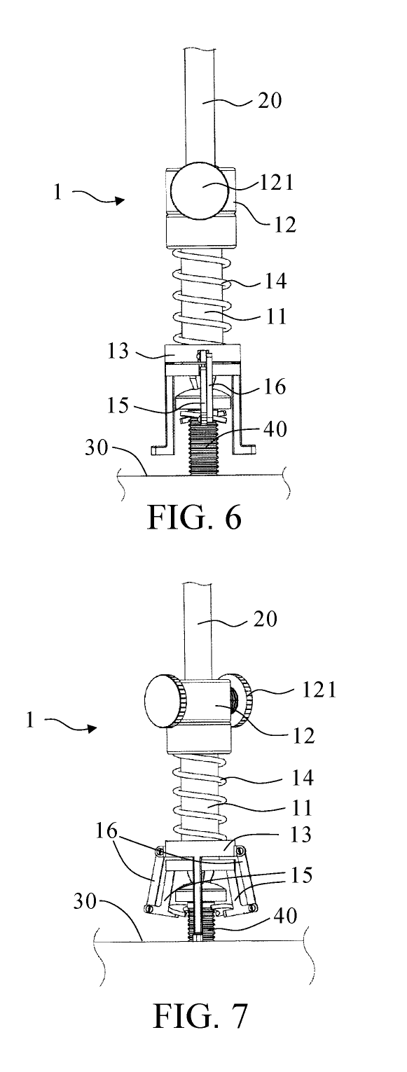

Referring to FIG. 1 and FIG. 2, there are a schematic view and an explode view respectively of a screw clamping device 1 according to an embodiment of the present invention. As shown in the diagrams, the screw clamping device 1 comprises a body 11, a fixing unit 12, a pressing unit 13, a resilient unit 14, a clamping unit 15 and a connecting unit 16. The body 11 is a hollow-core cylinder. One end of the body 11 has four dents d. The fixing unit 12 fits around the body 11 and rotates relative to the body freely. The fixing unit 12 comprises a plurality of screws 121 that penetrating the fixing unit 12 The pressing unit 13 is pressed against on the body 11. Referring to FIG. 5, an end of the pressing unit 13 is an L-shaped object and received in the dents d of the body 11 for pressing against the surface of a working object 30. The resilient unit 14 is disposed between the terminal portion of the body 11 and the pressing unit 13. Referring to FIG. 4, the clamping unit 15 is rotatably disposed on the body 11 and received in the dents d of the body 11. The clamping unit 15 comprises two clamping arms which are symmetrically arranged thereon. Each clamping arm has one end in the form of a C-shaped object. Referring to FIG. 6, the C-shaped objects are formed at the two clamping arms, respectively, obliquely in opposite directions. Therefore, to grip a screw 40, the C-shaped objects of the clamping unit 15 slide into the head of the screw 40 obliquely. With the C-shaped objects being formed at the two clamping arms obliquely in opposite directions, not only is it impossible for the screw 40 to tilt in the course of the aforesaid process, but the C-shaped objects are also applicable to screws 40 of different sizes. The connecting unit 16 has one end connected to the pressing unit 13 and the other end connected to the clamping unit 15. The connecting unit 16 drives the clamping unit 15 to rotate while the fixing unit 12 is moving axially.

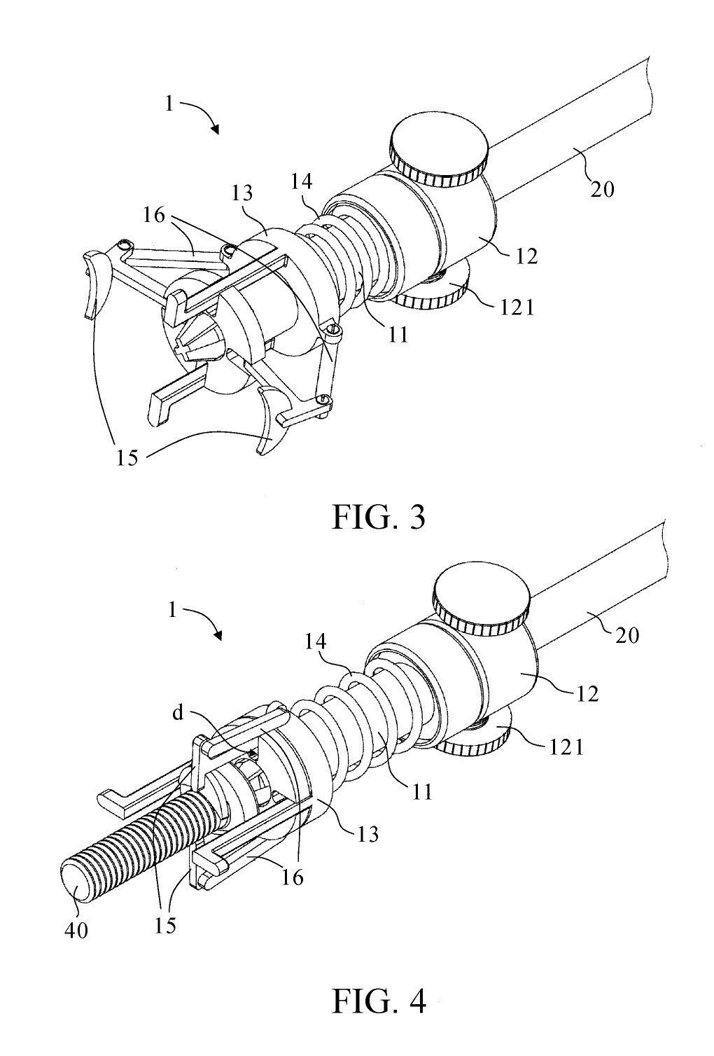

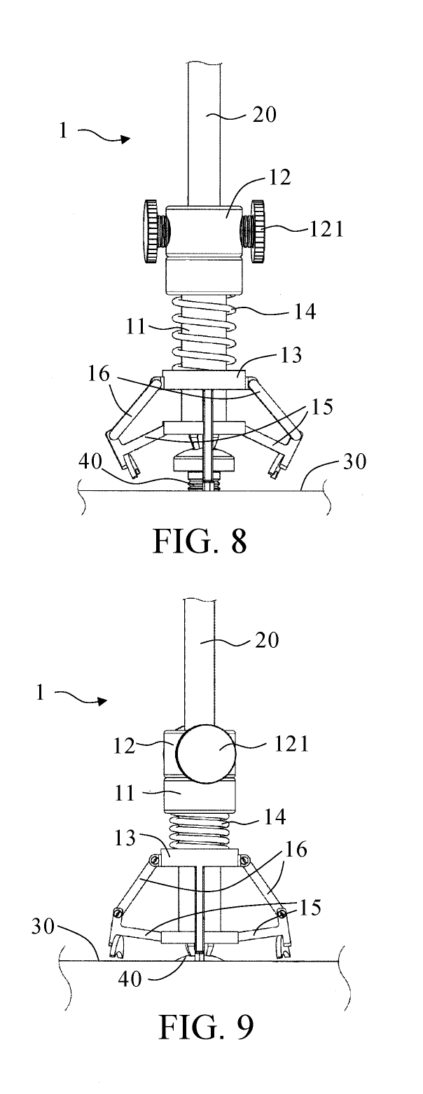

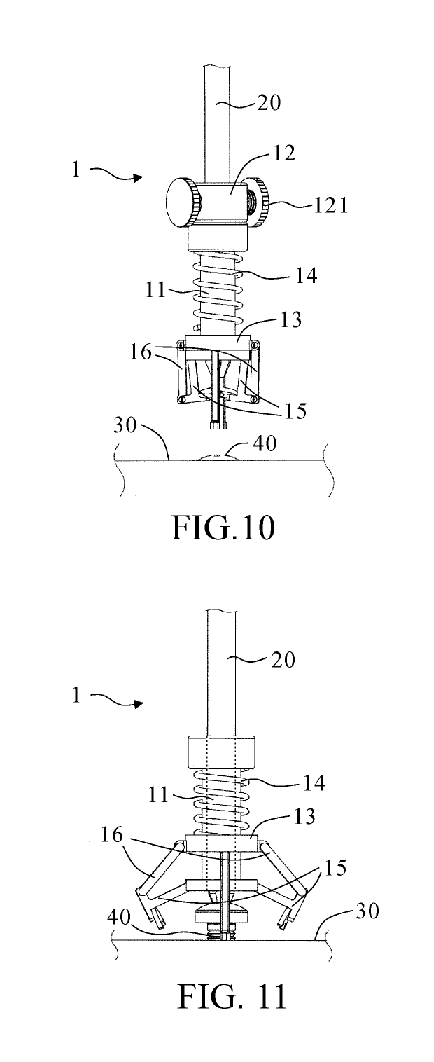

Referring to FIG. 3 through FIG. 9, there are shown schematic views of operation of the screw clamping device 1 according to the aforesaid embodiment of the present invention. As shown in FIG. 3 through FIG. 9, the screw clamping device 1 fits around a screwdriver 20, the screwdriver 20 penetrates the body 11 and fixing unit 12 axially and is coupled to the fixing unit 12 through screws 121. Afterward, as shown in FIG. 5, the intended screw 40 is placed at one end of the screwdriver 20, and then both the screwdriver 20 and the screw 40 are moved to the working object 30. As shown in FIG. 6, with the screw 40 being clamped by the clamping unit 15 of the screw clamping device 1, the screw 40 is clamped and fixed to one end of the screwdriver 20, allowing the screw 40 to be driven into the working object 30 while being rotated by a user. As shown in FIG. 7, when the pressing unit 13 of the screw clamping device 1 coming into contact with the working object, the fixing unit 12 is move down according to the rotation of the screwdriver 20 and pressing the top of the body 11 for moving down the body 11. Simultaneously, the movements of the lower end of the body 11 drives the clamping unit 15 to rotate. Therefore, the two C-shaped objects at the front ends of the clamping unit 15 are no longer clamping the screw 40. As shown in FIG. 8, in the situation where the user keeps driving the screw 40 into the working object 30 by rotating the screw 40, the rotation of the screwdriver 20 causes the screw 40 to be driven into the working object 30 but does not cause the body 11 to rotate, because the body 11 and the fixing unit 12 are movable. The body 11 compresses the resilient unit 14 and move downward along the screwdriver 20; as a result, the connecting unit 16 drives the clamping unit 15 to rotate and stretch outward, thereby releasing the screw 40. As shown in FIG. 9, the clamping unit 15 is no longer clamping the screw 40 after the screw 40 has been driven into the working object 30. As shown in FIG. 10, by contrast, the pressing unit 13 becomes a fixing end of the resilient unit 14 as soon as the screw 40 is screwed in or out of the working object 30, and in consequence the body 11 moves upward while restoration of the initial state of the resilient unit 14 is taking place; hence, again, the connecting unit 16 drives the clamping unit 15 to rotate and thereby restore or clamp the screw 40. Therefore, the screw clamping device 1 of the present invention prevents the screw 40 from falling off or even getting missing while being loosened or tightened. Furthermore, the screw clamping device 1 of the present invention can be coupled to the screwdrivers 20 of different sizes to further broaden the application of the screw clamping device 1.

Referring to FIG. 11, in another embodiment, the present invention dispenses with the fixing unit 12 as described below. The inner wall of the body 11 is made of an elastic material, such as rubber. After penetrating the body 11, the screwdriver 20 stretches the body 11 and thus is in tight contact with the inner wall of the body 11. Owing to the friction between the inner wall and the screwdriver 20, the screwdriver 20 and the body 11 are fixed to each other.

Given the aforesaid technical features of the screw clamping device 1 of the present invention, the body 11, the resilient unit 14, the pressing unit 13, the connecting unit 16 and the clamping unit 15 each rotate together with the screwdriver 20. The screw clamping device 1 rotates about the screw 40 without collisions, because the screw 40 is located at the center of each of the two clamping units 15.

As mentioned before, the present invention dispenses with the fixing unit 12, thereby further simplifying the structure of the screw clamping device 1.

The above embodiments are illustrative of the features and effects of the present invention rather than restrictive of the scope of the substantial technical disclosure of the present invention. Persons skilled in the art may modify and alter the above embodiments without departing from the spirit and scope of the present invention. Therefore, the scope of the protection of rights of the present invention should be defined by the appended claims.

What is claimed is:

1. A screw clamping device, comprising:
a body being a hollow-core cylinder, being subject to axial penetration of a screwdriver, and being movable axially in synchrony with rotation of the screwdriver;
a pressing unit pressed against the body and adapted to press against a surface of a working object;
a resilient unit disposed between the body and the pressing unit;
a clamping unit rotatably connected to the body; and
a connecting unit with an end connected to the pressing unit and another end connected to the clamping unit,
wherein the connecting unit drives the clamping unit to rotate while the body is moving axially.

2. The screw clamping device of claim 1, wherein the clamping unit comprises at least a clamping arm with an end in a form of a C-shaped object.

3. The screw clamping device of claim 1, wherein an end of the pressing unit comprises an L-shaped object.

4. The screw clamping device of claim 1, wherein an end of the body comprises a plurality of dens for receiving the pressing unit and the clamping unit.

5. The screw clamping device of claim 1, wherein the body comprises an inner wall, such that the screwdriver is in tight contact with the inner wall for fixing the body.

6. The screw clamping device of claim 2, wherein the clamping arms are in number of two and symmetrically arranged on the clamping unit, with two said C-shaped objects formed at two said clamping arms, respectively, obliquely in opposite directions.

7. A screw clamping device, comprising:
a body being a hollow-core cylinder, being subject to axial penetration of a screwdriver;
a fixing unit connected to the body axially and fixed with the screwdriver, the fixing unit being driven for pressing against the body moved axially when the screwdriver is rotating;
a pressing unit pressed against the body and adapted to press against a surface of a working object;
a resilient unit disposed between the body and the pressing unit;
a clamping unit rotatably connected to the body; and
a connecting unit with an end connected to the pressing unit and another end connected to the clamping unit,
wherein the connecting unit drives the clamping unit to rotate while the body is moving axially.

8. The screw clamping device of claim 7, wherein the clamping unit comprises at least a clamping arm with an end in a form of a C-shaped object.

9. The screw clamping device of claim 7, wherein an end of the pressing unit comprises an L-shaped object.

10. The screw clamping device of claim 7, wherein an end of the body comprises a plurality of dens for receiving the pressing unit and the clamping unit.

11. The screw clamping device of claim 7, wherein the fixing unit comprises a plurality of screws penetratingly disposed at the fixing unit to press against the screwdriver.

12. The screw clamping device of claim 8, wherein the clamping arms are in number of two and symmetrically arranged on the clamping unit, with two said C-shaped objects formed at two said clamping arms, respectively, wherein the two C-shaped objects are oblique in opposite directions.
